(19) United States
(12) Patent Application Publication
(10) Pub. No.: US 2025/0176009 A1
(43) Pub. Date: May 29, 2025

(54) DETERMINISTIC COMMUNICATION WITH DUAL-CONNECTIVITY

(71) Applicant: Nokia Solutions and Nebworks Oy, Espoo (FI)

(72) Inventors: Hua CHAO, Shanghai (CN); Zhu Yan ZHAO, Hangzhou (CN); Jun SHEN, Hangzhou (CN); Yonggang WANG, Shanghai (CN); Tao TAO, Shanghai (CN); Ke Jie CHEN, Espoo (FI)

(21) Appl. No.: 18/864,800

(22) PCT Filed: May 12, 2022
(86) PCT No.: PCT/CN2022/092344

§ 371 Date: Nov. 11, 2024

(51) Int. Cl. H04W 72/543; H04W 72/20

(52) U.S. Cl. CPC H04W 72/543; H04W 72/20

(57) ABSTRACT

Embodiments of the present disclosure relate to methods, devices, apparatuses, and computer readable medium of. The method comprises: receiving a resource allocation request associated with a deterministic communication traffic; determining at least one recommended network device satisfying a deterministic requirement associated with the deterministic communication traffic; selecting at least one target network device from the at least one recommended network device; and transmitting, to the at least one target network device, an indication to allocate resources for at least one further deterministic communication traffic. In this way, by selection based on the transmission status and the specific latency, reliability and QoS requirement of deterministic communication traffic, the selected secondary node has better compliance with the scheduled deterministic communication traffic so that the established DC will be more robust.

### FIELD

Embodiments of the present disclosure generally relate to the field of telecommunication and in particular, to devices, methods, apparatus and computer readable storage media of deterministic communication with dual-connectivity (DC).

### BACKGROUND

In Rel-17, time-sensitive communication (TSC) is introduced into 3GPP to provide deterministic transmission capability without relying on any IEEE standards. Since then, 5G system (5GS) has defined enablers for generic TSC. Application Functions can request a service with certain Quality of Service (QoS) requirement as well as specific time synchronization requirement. A new NF AF is introduced to handle the time synchronization and individual QoS parameters and TSCAI determination.

To support high reliability by redundant transmission in user plane, 3GPP specified DC based end-to-end user plane path, which enables a terminal device to set up two redundant Protocol Data Unit (PDU) Sessions over the 5G network. DC involves two radio network nodes (RAN) in providing radio resources to a given UE. One of the two RAN acts as a Master RAN to select another RAN node, the Secondary RAN node, to exchange User Plane traffic of an UE.

### SUMMARY

In general, example embodiments of the present disclosure provide a solution for power management in DC.
In a first aspect, there is provided a device. A device comprises: at least one processor; and at least one memory including computer program codes. The at least one memory and the computer program codes are configured to, with the at least one processor, cause the device at least to receive a resource allocation request associated with a deterministic communication traffic (e.g Quality of Service, QoS, flow); determine at least one recommended network device satisfying a deterministic requirement associated with the deterministic communication traffic; select at least one target network device from the at least one recommended network device; and transmit, to the at least one target network device, an indication to allocate resources for at least one further deterministic communication traffic.
In a second aspect, there is provided a controller. The controller comprises at least one processor; and at least one memory including computer program codes. The at least one memory and the computer program codes are configured to, with the at least one processor, cause the controller at least to: upon receiving a deterministic event from a first network device, determine, from at least one candidate network device, at least one recommended network device satisfying a requirement associated with the deterministic event, wherein the deterministic event is in response to a resource allocation request received by the first network device associated with a deterministic communication traffic; and transmit, to the first network device, an indication of the at least one recommended network device.
In a third aspect, there is provided a method. The method comprises: receiving a resource allocation request associated with a deterministic communication traffic; determining at least one recommended network device satisfying a deterministic requirement associated with the deterministic communication traffic; selecting at least one target network device from the at least one recommended network device; and transmitting, to the at least one target network device, an indication to allocate resources for at least one further deterministic communication traffic.
In a fourth aspect, there is provided a method. The method comprises: upon receiving a deterministic event from a first network device, determining, from at least one candidate network device, at least one recommended network device satisfying a requirement associated with the deterministic event, wherein the deterministic event is in response to a resource allocation request received by the first network device associated with a deterministic communication traffic; and transmitting, to the first network device, an indication of the at least one recommended network device.
In a fifth aspect, there is provided a first apparatus. The first apparatus comprises: means for receiving a resource allocation request associated with a deterministic communication traffic; means for determining at least one recommended network device satisfying a deterministic requirement associated with the deterministic communication traffic; means for selecting at least one target network device from the at least one recommended network device; and means for transmitting, to the at least one target network device, an indication to allocate resources for at least one further deterministic communication traffic.
In a sixth aspect, there is provided a second apparatus. A second apparatus comprises: means for upon receiving a deterministic event from a first network device, determining, from at least one candidate network device, at least one recommended network device satisfying a requirement associated with the deterministic event, wherein the deterministic event is in response to a resource allocation request received by the first network device associated with a deterministic communication traffic; and means for transmitting, to the first network device, an indication of the at least one recommended network device.
In a seventh aspect, there is provided a non-transitory computer readable medium. The non-transitory computer readable medium comprises program instructions for causing an apparatus to perform the method according to the third aspect.
In an eighth aspect, there is provided a non-transitory computer readable medium. The non-transitory computer readable medium comprises program instructions for causing an apparatus to perform the method according to the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network system in which example embodiments of the present disclosure may be implemented;

FIG. 2 illustrates a signaling chart illustrating an example TSC procedure in 5GS according to example network system illustrated in FIG. 1.

FIG. 3A illustrates a signaling chart illustrating an example DC establishment process in TSC according to some example embodiments of the present disclosure;

FIG. 3B illustrates a signaling chart illustrating an example DC re-establishment process in TSC according to some example embodiments of the present disclosure;

FIG. 4A illustrates a signaling chart illustrating an example DC establishment process in TSC according to alternative example embodiments of the present disclosure;

FIG. 4B illustrates a signaling chart illustrating an example DC re-establishment process in TSC according to the alternative example embodiments of the present disclosure;

FIG. 5 illustrates a schematic diagram illustrating an example controller module according to some example embodiments of the present disclosure;

FIG. 6 illustrates a flowchart of an example method for secondary node selection implemented at a network device according to example embodiments of the present disclosure;

FIG. 7 illustrates a flowchart of an example method for secondary node selection implemented at a controller according to example embodiments of the present disclosure;

FIG. 8 illustrates a simplified block diagram of an apparatus that is suitable for implementing example embodiments of the present disclosure; and

FIG. 9 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), a further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The term “Time Sensitive Communication (TSC)” refers to a communication service that supports deterministic communication (i.e. which ensures a maximum delay) and/or isochronous communication with high reliability and availability. It is about providing packet transport with QoS characteristics such as bounds on latency, loss, and reliability, where end systems and relay/transmit nodes may or may not be strictly synchronized. It should be appreciated that the deterministic communication traffic may refer to different granularity in different generation of communication systems. For example, in case of a 5GS, the deterministic communication traffic may refer to a deterministic communication QoS flow. The QoS Flow is the finest granularity of QoS differentiation in the PDU Session. A QoS Flow ID (QFI) is used to identify a QoS Flow in the 5G System.

For current Rel-17, it is out of scope of 3GPP how to make use of the end-to-end duplicate paths for redundant traffic delivery. Conventionally, the DC is a generic capability to enable higher reliability to wireless traffic connections. However, during the selection of a secondary RAN node to establish redundant connectivity, the traffic characteristics, especially deterministic traffic are not taken into consideration. The Master RAN node determine if dual connectivity shall be set up under consideration of the Redundant Sequence Number (RSN) and/or PDU session pair ID and ensure appropriate PDU session handling to guarantee fully redundant user plane paths.

In the case that deterministic communications, in order to facilitate the redundancy within the radio interface, several extra factors should be considered during the DC secondary node selection to satisfy deterministic traffic requirements. These factors may comprise:
Latency guarantees:
   the secondary node selection method needs to make sure that the xHaul transport network (fronthaul, backhaul and middle Haul) also provide latency guarantees; RAN bandwidth availability:
   the air interface resources need to be checked before secondary node is added into DC to allow the duplicate traffic goes through a new path with enough resources, especially resources for semi-static scheduling for low latency transmission;
Node reliability and availability:
   Node healthy;
   Node available/coverage in UE mobile routing.

However, conventional DC establishment solution/procedure does not take the deterministic traffic requirements into consideration.

In order to solve the above and other potential problems, embodiments of the present disclosure provide an improved secondary node selection mechanism. According to the secondary node selection mechanism, by selection based on the transmission status and the specific latency, reliability and QoS requirement of deterministic communication traffic, the selected secondary node has better compliance with the scheduled deterministic communication traffic so that the established DC will be more robust. Further, by means of AI inference, the SN selection/modification is more efficient and resilient.

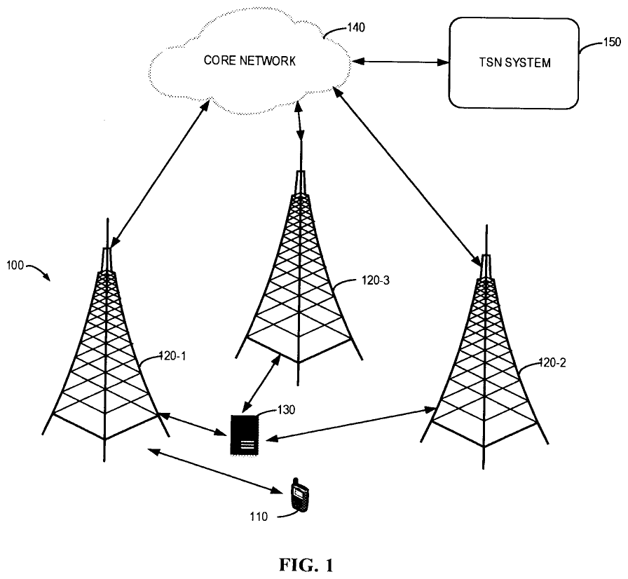

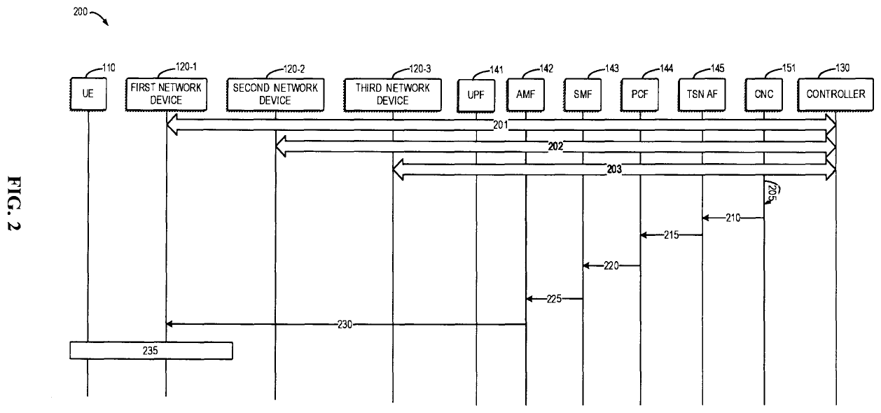

FIG. 1 illustrates an example network system 100 in which embodiments of the present disclosure can be implemented. In the network system 100, three network devices 120-1, 120-2, 120-3 are connected to a core network 140. The core network 140 is in turn connected with a TSN system 150. The communication with the TSN system 150 will be described in details with reference with FIG. 2. A terminal device 110 is connected with the first network device 120-1. The terminal device 110 may be also referred to as UE 110 hereinafter. The first network 120-1, second network device 120-2 and the third network device 120-3 may be referred to as gNBs 120-1, 120-2 and 120-3, such as, base stations for providing radio coverage to the terminal device 110. In the network system 100, a controller 130 is connected with all of three network devices 120-1, 120-2, 120-3. In some example embodiments, the controller 130 may also be deployed in one of the network devices. The controller 130 may be implemented as a RAN Intelligent Controller (RIC). A RAN Intelligent Controller (RIC) is a software-defined component of the Open Radio Access Network (Open RAN) architecture that's responsible for controlling and optimizing RAN functions. The controller 130 may gather static information and dynamic information from the connected network devices and perform user defined operations to control and optimize the functions of the network devices. In the illustrated embodiment, the controller 130 is deployed outside the RAN nodes (e.g. RIC equipment, connected with multiple network devices via E2 interface).

It is also to be understood that the number of the devices as shown in FIG. 1 are only for the purpose of illustration without suggesting any limitations. For example, the network 100 may include any suitable number of terminal devices and network devices adapted for implementing embodiments of the present disclosure.

Only for ease of discussion, the terminal device 110 is illustrated as a UE, and the first network device 120-1, the second network device 120-2 and the third network device 120-3 are illustrated as base stations. However, the UE and base station are only given as example implementations of the terminal device 110, the network devices 120-1, 120-2, 120-3, respectively, without suggesting any limitation as to the scope of the present application. Any other suitable implementations are possible as well.

The communications in the network system 100 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), and/or any further communication protocols. For the sake of convenience and without loss of generality, the network system 100 described hereafter relates to a 5GS.

FIG. 2 illustrates a signaling chart illustrating an example TSC procedure 200 according to example network system illustrated in FIG. 1. As FIG. 2 shown, the network architecture comprises a UE 110, a first network device 120-1, a second network device 120-2, a third network device 120-3, core network 140, a central network controller 151 of the TSN system 150 and a controller 130. The core network 140 may composed of core network functions (NFs), such as a User Plane Function (UPF) 141, an Access and Mobility Management Function (AMF) 142, a Session Management Function (SMF) 143, a Policy Control Function (PCF) 144 and a TSN Application Function (TSN AF) 145. FIG. 2 can be viewed as one particular implementation of the network system 100 of FIG. 1.

As shown, at step 205, the CNC 151 may perform a TSN stream scheduling. The TSN AF 145 interfaces towards the CNC 151 for TSN configuration information. Thus, at 210, the CNC 151 transmits the TSN configuration information to the TSN AF 145. When the configuration information is provided by the CNC 151, the TSN AF 145 may extract relevant parameters from the configuration. The TSN AF 145 may calculate traffic pattern parameters (such as burst arrival time and periodicity). TSN AF 145 may also obtain the flow direction. Further, a Survival Time may be pre-configured in TSN AF 145. At step 215, the TSN AF 145 determines TSC Assistance Container and provides it to the PCF 144. The PCF 144 receives the TSC Assistance Container from the TSN AF 145 and forwards it to the SMF 143 at step 220 as part of policy and charging control (PCC) rule. The SMF 143 may bind a PCC rule with a TSC Assistance Container to a QoS Flow. The SMF 143 may use the TSC Assistance Container to derive the TSCAI for that QoS Flow and sends the derived TSCAI to the network devices. After the SMF 143 determines the TSCAI, the SMF 143 may send the TSCAI and QoS information to AMF 142 at step 225. Then, the AMF 142 transmits the TSCAI and QoS information to first network device 120-1 at step 230. Upon receiving the information, the first network device 120-1 reserves resources for the scheduled QoS flow.

In addition, the controller 130 has subscribed to information of the network devices 120-1, 120-2, 120-3. The information may comprise static information of the network or the current transmission status so that the controller 130 may be able to control or optimize the operation of the network based thereon.

As shown, the terminal device 110 is in the radio coverage of all three network devices so that a dual connectivity can be established between the terminal device 110 and either two of the three network devices 120-1, 120-2, 120-3. In order to enhance the reliability by redundant transmission, the network device 120-1 may select one of the network devices to establish a redundant transmission path with the UE 110 with assistance of the controller 130.

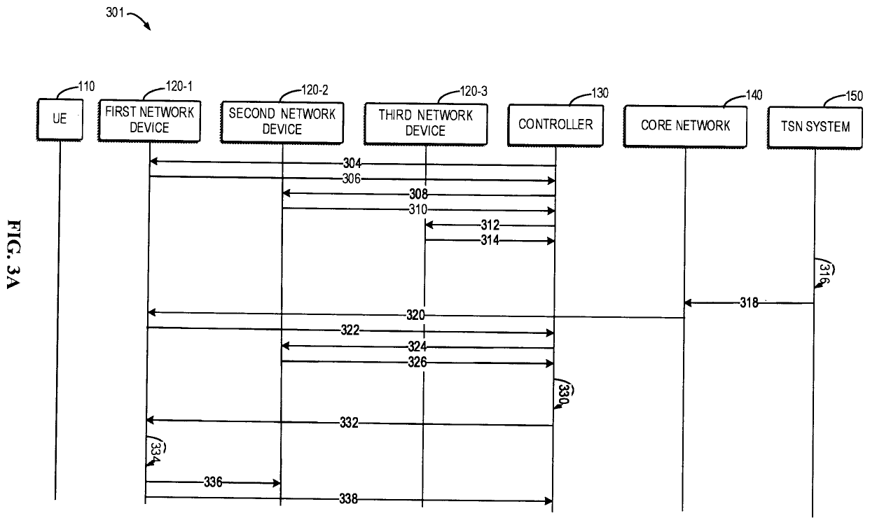

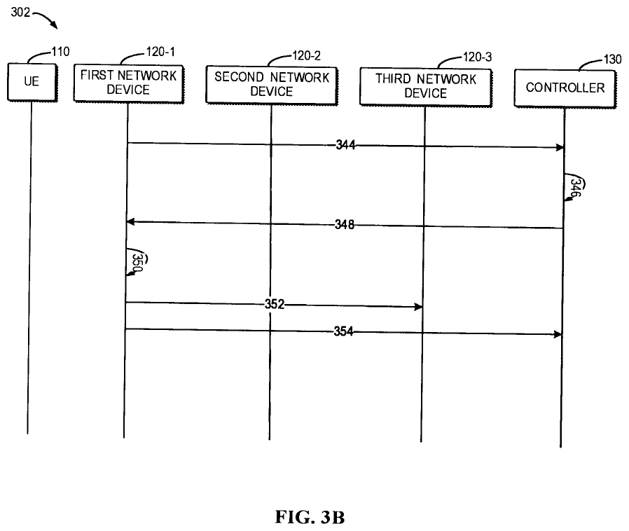

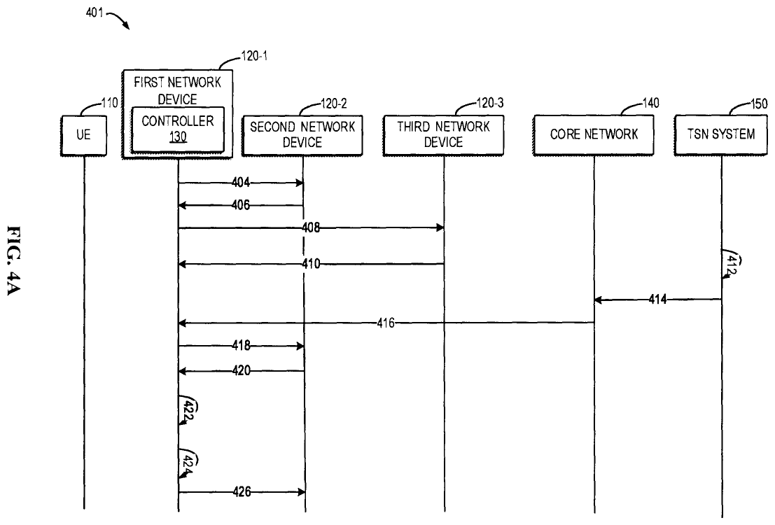

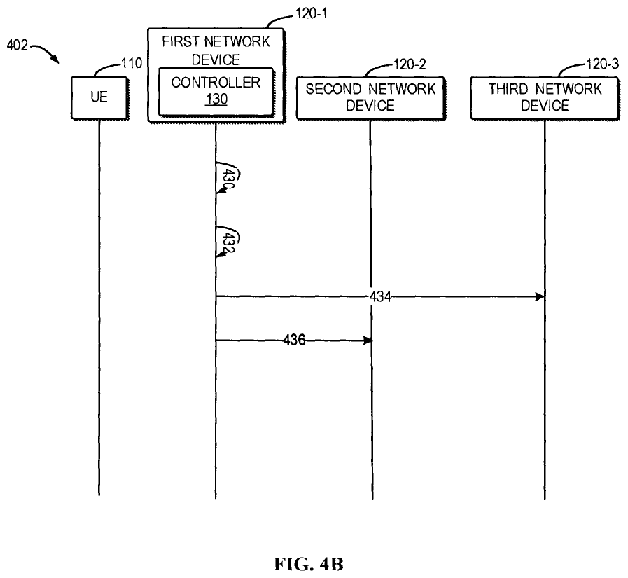

Principle and implementations of the present disclosure will be described in detail below with reference to FIGS. 3A to 4B. FIGS. 3A to 4B respectively illustrate signaling charts illustrating an example DC establishment processes 301 and 401 and DC re-establishment processes 302 and 402 in TSC according to some example embodiments of the present disclosure. For the purpose of discussion, the processes 301 to 402 will be described with reference to FIGS. 1 and 2. The processes 301 and 302 may involve the first network device 120-1, the second network device 120-2, the third network device 120-3, the controller 130, the core network 140, and the TSN system 150. The processes 401 and 402 may involve the first network device 120-1, the second network device 120-2, the third network device 120-3, the core network 140, and the TSN system 150.

Now reference is made to FIG. 3A. In this example embodiment, the controller 130 is deployed as a separate device outside the network device 120-1. In the process 301, the controller 130 transmits respective subscription request for deterministic events associated with a deterministic communication QoS flow, also referred to as TSC specific events, to all the network devices 120-1, 120-2, 120-3 respectively at steps 304, 308, 312. Then, the network devices 120-1, 120-2, 120-3 transmit a response indicating the subscription is created to the controller 130 respectively at steps 306, 310, 314. At this moment, the controller 130 has subscribed to deterministic events of respective network in the network. The deterministic events may be triggered at network devices upon receiving scheduling information for deterministic transmission traffic. It should be noted that the network devices 120-1, 120-2, 120-3 all support deterministic transmission. Therefore, the network devices 120-1, 120-2, 120-3 can also be referred to as candidate network device. In some example embodiments, upon receiving the subscription request from the controller 130, the network device with deterministic transmission capability will respond to the controller 130 with positive feedback indicating that it is capable of deterministic transmission. In some example embodiments, the information associated with a deterministic communication QoS flow may be reported upon being triggered by events, for example in response to a resource allocation request. Further, the information associated with a deterministic communication QoS flow or relevant status information of the network device may be reported periodically. In some example embodiments, the deterministic events may include receipt of new TSCAI from TSN system 150 about a new TSC QoS flow establishment or updated TSCAI about an existing TSC QoS flow. In some example embodiments, the deterministic events may also indicate the need of dual-connectivity and QoS requirement, for example a PDU session ID, a QFI, TSCAI, QoS parameters. In some example embodiments, the controller 130 may transmit a request for an extra report from the network devices. The extra report may comprise contents especially impacting deterministic traffic, such as link quality/HARQ retransmission rate, transport latency, and resource availability for semi-static scheduling etc. The extra report may also comprise RAN reliability, such as equipment warning, RAN health information; UE measurement information; xHaul transport latency capability including fronthaul, backhual and/or middlehaul; Indication of the PDU Session is to be handled redundantly, i.e. PDU session pair ID and/or RSN.

At step 316, the TSN system 150 performs TSN stream scheduling and transmits the information associated with a scheduled deterministic communication QoS flow to the core network 140 at step 318. The core network 140 derives TSCAI and QoS information from the received information and transmits the TSCAI and QoS information as a resource allocation request for the deterministic QoS flow to the first network device 120-1 at step 320.

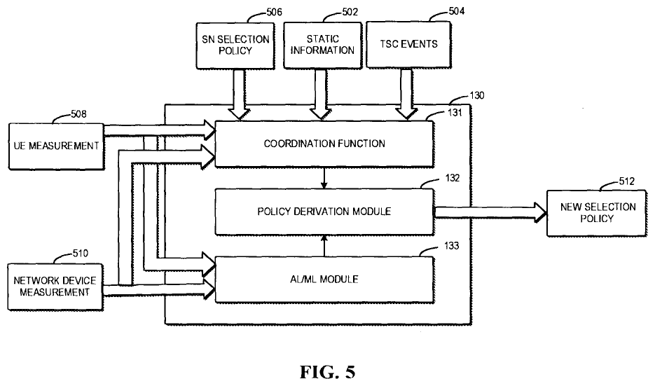

Upon receiving the information, in addition to allocation of resources for the deterministic communication QoS flow, the first network device 120-1 acting as the master network device needs to select a secondary network device to establish a dual connectivity. At step 322, the first network device 120-1 forwards a deterministic event in response to the resource allocation request to the controller 130. When the controller receives the deterministic event, the controller 130 prepares to select at least one recommended network device from the candidate network device for the first network device 120-1. In order to perform the selection, the controller 130 may determine whether the information acquired for candidate network devices are sufficient. In the example embodiment illustrated in FIG. 3A, the controller 130 determines that the information associated with the second network device 120-2 is not sufficient or a presence of the acquired information is too long. Therefore, the controller 130 transmits a request for updated transmission status information to the second network device 120-2 at step 324 and receives the updated information at step 326. Further, the controller 130 determines that the deterministic information associated with the third network device 120-3 is sufficient and no need to update. Therefore, the controller 130 does not request for an update. At step 330, the controller 130 selects at least one recommended network device satisfying a requirement associated with the deterministic event. In the illustrated embodiment, the candidate network devices are second network device 120-2 and the third network device 120-3. The controller 130 may perform artificial intelligence (AI) inference based on the information acquired and according to a machine learning model. In some example embodiments, the controller 130 determines a performance prediction of the at least one candidate network based at least partly on the transmission status information according to a prediction model. In the illustrated embodiment, the controller 130 selects the second network device 120-2 as the recommended network device. The AI inference performed by the controller 130 will be described in details below with reference to FIG. 5.

When the recommended network devices are selected, the controller 130 transmits an indication of the derived recommended network device to the first network device 120-1 at step 332. In some example embodiments, the indication of the at least one recommended network device is comprised in a policy for a control plane, e.g. in terms of global RAN node ID list. The first network device 120-1 determines at least one target network device from the derived recommended network device at step 334. For example, the target network device is selected based on pre-configured rules. Since there is only one recommended network device, the second network device 120-2 is selected as the target network device. In some example, the indication of the at least one recommended network device is in form of a prioritized list and the target network device is selected based on the respective priority of the at least one recommended network. At step 336, the first network device 120-1 transmits an indication to allocate resources for at least one further deterministic communication QoS flow to the at least one target network device, i.e. the second network device 120-2. At step 338, the first network device 120-1 informs the controller 130 that the second network device 120-2 is selected to be the secondary network device for establishing a dual connectivity with the UE 110. In some example embodiments, the controller 130 may utilize the indication of the selection of the target network device to optimize the subsequent selection at step 330.

When the second network device 120-2 receives the request to be added as a secondary network device, the second network device 120-2 will reserve resources for DC. In some example embodiments, after the UE 110 performs a Random Access Procedure, a connection between the second network device 120-2 and the UE 110 may be established.

During the subsequent communication, the transmission status associated with the deterministic transmission may change. An update of the recommended network device for DC may be required. The update process will be described in details below with reference to FIG. 3B.

FIG. 3B illustrates a signaling chart illustrating an example DC re-establishment process 302 in TSC according to some example embodiments of the present disclosure. In process 302, when the first network device 120-1 detects a change associated with the deterministic communication QoS flow or determines that the at least one target network device is no longer suitable for the deterministic communication QoS flow, the first network device 120-1 forwards an indication of the change or an indication that the target network needs to be changed to the controller 130 at step 344. For example, the first network device 120-1 may ascertain that the UE's communication quality is unsatisfactory for a predefined period due to e.g., mobility, handover and/or network traffic load. The dissatisfaction may be detected based on e.g., detected packet error rate, received UE's HARQ feedback or measurement reports. In other example embodiments, the indication may be reported by the target network device, i.e. the second network 120-2. In this case, different to process 301, an updated TSCAI will be included in the indication. The updated TSCAI Burst Arrival Time (BAT) shows the latest potential BAT for the changed path. The updated TSCAI BAT may be determined according to the following equation:

Updated TSCAI BAT=n*periodicity+TSCAI BAT (in process 301) (1)

where n is an integer so that the updated TSCAI BAT is greater than the current time.

At step 346, the controller 130 determines at least one updated recommended network device based on the indication of the update. In the example embodiment illustrated in FIG. 3B, the third network device 120-3 is selected as the updated recommended network device. At step 348, the controller 130 transmits an indication of the at least one updated recommended network device to the first network device 120-1. At step 350, the first network device 120-1 selects at least one updated target network device form the at least one updated recommended network device. At step 352, the first network device 120-1 transmits an indication to allocate resources for at least one further deterministic communication QoS flow to the at least one updated target network device, i.e. the third network device 120-3. At step 354, the first network device 120-1 informs the controller 130 that the third network device 120-3 is selected to be the secondary network device for establishing a dual connectivity with the UE 110.

According to the example embodiments, there is provided an improved mechanism for secondary node selection in TSC. Based on the selection mechanism, by means of an AI inference performed by an external controller based on the transmission status and the specific latency, reliability and QoS requirement of deterministic communication traffic, the SN selection/modification is more efficient and resilient. Due to the global data collection and network status prediction, the robustness of the established DC will be enhanced.

Now reference is made to FIG. 4A. In this example embodiment, the controller 130 is deployed inside the network device 120-1. In the process 401, the first network device 120-1 transmits respective subscription request for deterministic events associated with a deterministic communication QoS flow to the network devices 120-2, 120-3 respectively at steps 404, 408. Then, the network devices 120-2, 120-3 transmit a response indicating the subscription is created to the first network device 120-1 respectively at steps 406, 410. At this moment, the first network devices 120-1 has subscribed to deterministic events of other network devices in the network.

At step 412, the TSN system 150 performs TSN stream scheduling and transmits the information associated with a scheduled deterministic communication QoS flow to the core network 140 at step 414. The core network 140 derives a TSCAI and QoS information from the received information and transmits the TSCAI and QoS information as a request to allocation of resources for the deterministic QoS flow to the first network device 120-1, at step 416.

At step 418, the first network device 120-1 transmits a request for updated transmission status information to the second network device 120-2. At step 420, the first network device 120-1 receives the updated transmission status information from the second network device 120-2. At step 422, the first network device 120-1 determines at least one recommended network device satisfying a requirement associated with the deterministic event. In the illustrated embodiment, the candidate network devices are second network device 120-2 and the third network device 120-3. Similarly, the first network device 120-1 may perform artificial intelligence (AI) inference based on the information acquired and according to a machine learning model. The first network device 120-1 determines at least one target network device from the derived recommended network device at step 424. At step 426, the first network device 120-1 transmit an indication to allocate resources for at least one further deterministic communication QoS flow to the at least one target network device, i.e. the second network device 120-2.

FIG. 4B illustrates a signaling chart illustrating an example DC re-establishment process 402 in TSC according to some example embodiments of the present disclosure. In process 402, when the first network device 120-1 detects a change associated with the deterministic communication QoS flow or determines that the at least one target network device is no longer suitable for the deterministic communication QoS flow, the first network device 120-1 determines at least one updated recommended network device based on the detected updated information at step 430. At step 432, the first network device 120-1 selects at least one updated target network device from the at least one updated recommended network device. In the example embodiment illustrated in FIG. 4B, the third network device 120-3 is selected as the updated target network device. At step 434, the controller 130 transmits an indication to allocate resources for at least one further deterministic communication QoS flow to the at least one updated target network device, i.e. the third network device 120-3.

According to the example embodiments, there is provided an improved mechanism for secondary node selection in TSC. Based on the selection mechanism, by means of an AI inference performed by a master network device with assistance of an internal AI component based on the transmission status and the specific latency, reliability and QoS requirement of deterministic communication traffic, the SN selection/modification is more efficient and resilient. Due to the global data collection and network status prediction, the robustness of the established DC will be enhanced.

FIG. 5 illustrates a schematic diagram illustrating an example controller 130 according to some example embodiments of the present disclosure. In some example embodiments, the controller 130 may be implemented as a RAN Intelligence Controller (RIC). Specifically, the controller 130 may be implemented as a near real time RIC (Near-RT RIC). For example, the Near-RT RIC enables near real-time control and optimization of RAN (e.g. O-RAN) nodes and resources over the E2 interface with near real-time control loops (i.e., 10 ms to 1 s). In some example embodiments, the controller 130 may use monitor, suspend/stop, override and/or control primitives to control the behaviors of network devices. The controller 130 can be configured to leverage AI/ML based technologies by means of the various AI/ML models for different objectives. For example, the ML models may be trained offline in other components, while the model inference will be executed real-time in the controller 130. The controller 130 may be configured to process information about status of the network infrastructure (e.g., number of users, load, throughput, resource utilization), as well as additional context information from sources outside of the network devices and to leverage Artificial Intelligence (AI) and ML algorithms to determine and apply control policies and actions on the network devices.

As illustrated in FIG. 5, the controller 130 receives various information from different entities. For example, the controller 130 may receive TSC events 504 from a network device, for example the first network device 120-1 as illustrated in FIG. 3A at corresponding step 322. The TSC events 504 may include PDU session ID, QFI, TSCAI and QoS information. The controller 131 may receive static information 502 of the network from entities of network, such as Network Management System (NMS), Operation Administration and Maintenance (OAM), and Service Management and Orchestration (SMO). The static information 502 may include location of the network device, frequency, antenna height, antenna direction, transmission setting and UPF. The controller 130 may also receive the current secondary node selection policy 506 or secondary node selection parameters from e.g., a non-RT RIC via A1 interface. The controller 130 may receive UE measurement 508 from a network device controlling the UE. UE measurement 508 may include beam parameters, Channel measurement (Received Signal Strength Indicator). The controller 130 may receive real-time network device measurement 510 from the network devices. The network device measurement 510 may include current cell load and interference etc. In some example embodiments, if the controller 130 determines that the network device measurement 510 of one specific network device exists for a long time or hasn't been acquired, the controller 130 may transmit a request for the network device measurement 510 to the corresponding network device.

The controller 130 comprises a coordination function 131. The static information 502, the TSC events 504, current secondary node selection policy 506 and the UE measurement 508 are provided to the coordination function 131. The coordination function 131 is configured to determine a prioritized list of input parameters based on the provided information. Further, the controller 130 also comprises an AL/ML module 131. The ML models with desired functions have been trained and deployed in the AL/ML module 133. The UE measurement 508 and the network device measurement 510 are provided to the AL/ML module 133. In the illustrated embodiment, the AL/ML module 133 is configured to predict the UE mobility trajectory and cell load of the network device based on the provided measurement information. For example, prediction algorithm may include some particular ML methods, such as Deep Neural Network (DNN), Extreme Gradient Boosting Trees (XGBoost), Semi-Markov, and SVM for traffic mobility prediction. The controller 130 also comprises a policy derivation module 132. The policy derivation module 132 is configured to receive inputs from both the coordination function 131 and the AL/ML module 133 and to derive a selection policy 512 based on the input. For example, the selection policy 510 may indicate the selected at least one recommended network device. For example, the at least one recommended network device is selected in accordance with a determination that its cell load prediction is in conformity with the scheduled deterministic communication. The indication of the at least one recommended network device may be in form of a prioritized list.

According to the example embodiments, there is provided an improved entity for secondary node selection in TSC. By processing all the information collected across the entire network system and predicting the network device performance and UE mobility, the recommended network devices selection is more comprehensive.

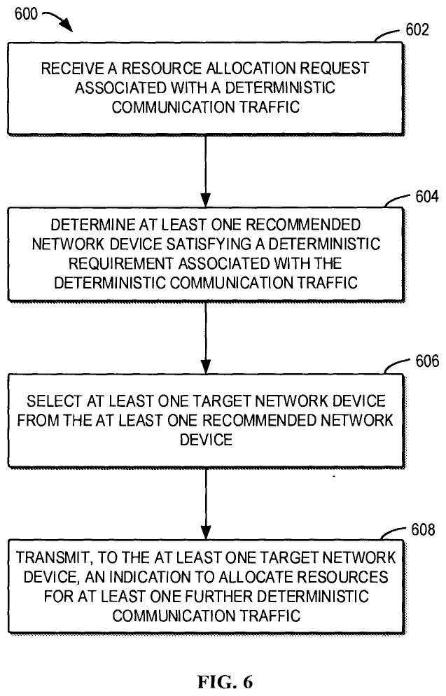

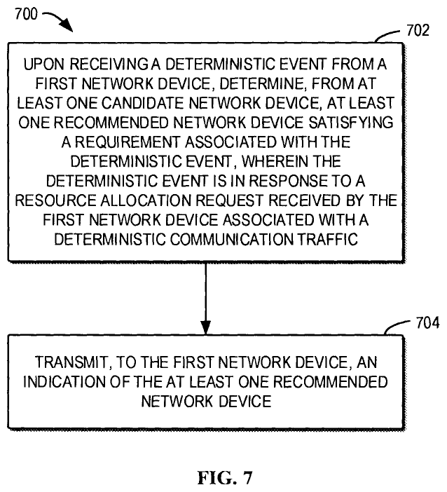

Corresponding to the processes 301 to 402 described in connection with FIGS. 3A to 4B, embodiments of the present disclosure provide a solution for selecting a target network device to establish redundant communication in assistance with an AI component. These methods will be described below with reference to FIGS. 6 and 7.

FIG. 6 illustrates a flowchart of an example method 600 for secondary node selection implemented at a network device according to example embodiments of the present disclosure. The method 600 can be implemented at the first network device 120-1 shown in FIG. 1. For the purpose of discussion, the method 600 will be described with reference to FIG. 1. It is to be understood that method 600 may further include additional blocks not shown and/or omit some shown blocks, and the scope of the present disclosure is not limited in this regard.

As shown in FIG. 6, at 602, the first network device 120-1 receives a resource allocation request associated with a deterministic communication Quality of Service (QoS) flow.

At 604, the first network device 120-1 determines at least one recommended network device satisfying a deterministic requirement associated with the deterministic communication QoS flow.

At 606, the first network device 120-1 selects at least one target network device from the at least one recommended network device.

At 608, the first network device 120-1 transmits, to the at least one target network device, an indication to allocate resources for at least one further deterministic communication QoS flow.

In some example embodiments, in order to determine at least one recommended network device, the first network device 120-1 may transmit, to a controller, a deterministic event in response to the resource allocation request and receive, from the controller, an indication of the at least one recommended network device.

In some example embodiments, a candidate network device is determined as a recommended network device in accordance with a determination that a performance prediction of the candidate network device is in accordance with the requirement associated with the deterministic event, and the performance prediction is determined based at least partly on transmission status information of the candidate network device according to a prediction model.

In some example embodiments, the first network device 120-1 may transmit, to the controller, an indication that at least one target network device is selected for optimization.

In some example embodiments, the first network device 120-1 may further transmit, to the controller, a new deterministic event upon receiving an indication of a change associated with the deterministic communication QoS flow; receive, from the controller, an indication of at least one updated recommended network device satisfying a requirement associated with the new deterministic event; select at least one updated target network device from the at least one updated recommended network device; and transmit, to the at least one updated target network device, an indication to allocate resources for at least one further deterministic communication QoS flow.

In alternative example embodiments, in order to determine at least one recommended network device, the first network device 120-1 may obtain transmission status information of the at least one candidate network device associated with the deterministic communication QoS flow; determine a performance prediction of the at least one candidate network based at least partly on the transmission status information according to a prediction model; determine the candidate network device as a recommended network device in accordance with a determination that a performance prediction of a candidate network device is in accordance with the requirement associated with the deterministic event.

In alternative example embodiments, the first network device 120-1 may further transmit, to at least one candidate network device, a request for updated transmission status information in accordance with a determination that a presence period of the transmission status information exceeds a predefined limit; and receive, from the at least one candidate network, the updated transmission status information.

In alternative example embodiments, the first network device 120-1 may further optimize the prediction model based on the indication that at least one target network device is selected.

In alternative example embodiments, the first network device 120-1 may further determine at least one updated candidate network device based on the indication upon receiving at least one of: an indication of a change associated with the deterministic communication QoS flow or an indication that the at least one recommended network device is no longer suitable for the deterministic communication QoS flow; select at least one updated target network device from the at least one updated recommended network device; and transmit, to the at least one updated target network device, an indication to allocate resources for at least one further deterministic communication QoS flow.

In some example embodiments, the first network device 120-1 may further transmit, to the at least one candidate network device, an event subscription request for a deterministic event at the at least one candidate network device; and receive, from the at least one candidate network device, a response indicating that a subscription is created.

In some example embodiments, the transmission status information may comprise at least one of the following: cell load; current performance information; reliability; and transmission latency.

In some example embodiments, the resource allocation request comprises at least one of the following: Time-Sensitive Communication Assistant Information, TSCAI; Quality of Service, QoS, parameters; a QoS Flow Identifier, QFI; and an indication of a redundant deterministic communication QoS flow.

In some example embodiments, the indication of the at least one recommended network device is comprised in a policy for a control plane.

In some example embodiments, the at least one candidate network device is capable of deterministic transmission and the requirement associated with the deterministic event indicates at least: a latency; a bandwidth; reliability of a candidate network device; and availability of a candidate network device.

According to the example embodiments, there is provided an improved mechanism for secondary node selection in TSC. Based on the selection mechanism, by means of an AI inference performed by a master network device with assistance of an internal AI component based on the transmission status and the specific latency, reliability and QoS requirement of deterministic communication traffic, the SN selection/modification is more efficient and resilient. Due to the global data collection and network status prediction, the robustness of the established DC will be enhanced.

FIG. 7 illustrates a flowchart of an example method 700 for power measurement reporting implemented at a network device according to example embodiments of the present disclosure. The method 700 can be implemented at the controller 130 shown in FIG. 1. For the purpose of discussion, the method 700 will be described with reference to FIG. 1. It is to be understood that method 700 may further include additional blocks not shown and/or omit some shown blocks, and the scope of the present disclosure is not limited in this regard.

At 702, the controller 130 determines from at least one candidate network device, at least one recommended network device satisfying a requirement associated with the deterministic event upon receiving a deterministic event from a first network device. In this case, the deterministic event is in response to a resource allocation request received by the first network device associated with a deterministic communication QoS flow.

At 704, the controller 130 transmit, to the first network device, an indication of the at least one recommended network device.

In some example embodiments, in order to determine at least one recommended network device, the controller 130 may obtain transmission status information of the at least one candidate network device associated with the deterministic communication QoS flow; determine a performance prediction of the at least one candidate network based at least partly on the transmission status information according to a prediction model; and determine the candidate network device as a recommended network device in accordance with a determination that a performance prediction of a candidate network device is in accordance with the requirement associated with the deterministic event.

In some example embodiments, the controller 130 may transmit, to at least one candidate network device, a request for updated transmission status information in accordance with a determination that a presence period of the transmission status information exceeds a predefined limit; and receive, from the at least one candidate network, the updated transmission status information.

In some example embodiments, the controller 130 may transmit, to the first network device, a deterministic event subscription request for a deterministic event at the first network device; receive, from the first network device, a response indicating that a subscription is created; transmit, to the at least one candidate network device, an event subscription request for a deterministic event at the at least one candidate network device; and receive, from the at least one candidate network device, a response indicating that a subscription is created.

In some example embodiments, the at least one candidate network device is capable of deterministic transmission and the requirement associated with the deterministic event indicates at least: a latency; a bandwidth; reliability of a candidate network device; and availability of a candidate network device.

In some example embodiments, the controller 130 may receive, from the first network device, an indication that at least one target network device is selected; and optimize the prediction model based on the indication.

In some example embodiments, the controller 130 may determine at least one updated recommended network device based on the indication upon receiving at least one of: an indication of a change associated with the deterministic communication QoS flow or an indication that the at least one recommended network device is no longer suitable for the deterministic communication QoS flow; and transmit, to the first network device, an indication of the at least one updated recommended network device.

In some example embodiments, the transmission status information may comprise at least one of the following: cell load; current performance information; reliability; and transmission latency.

In some example embodiments, the resource allocation request comprises at least one of the following: Time-Sensitive Communication Assistant Information, TSCAI; Quality of Service, QoS, parameters; a QoS Flow Identifier, QFI; and an indication of a redundant deterministic communication QoS flow.

In some example embodiments, the indication of the at least one recommended network device is comprised in a policy for a control plane.

In some example embodiments, the at least one candidate network device is capable of deterministic transmission and the requirement associated with the deterministic event indicates at least: a latency; a bandwidth; reliability of a candidate network device; and availability of a candidate network device.

According to the example embodiments, there is provided an improved mechanism for secondary node selection in TSC. Based on the selection mechanism, by means of an AI inference performed by an external AI based controller based on the transmission status and the specific latency, reliability and QoS requirement of deterministic communication traffic, the SN selection/modification is more efficient and resilient. Due to the global data collection and network status prediction, the robustness of the established DC will be enhanced.

In some example embodiments, a first apparatus capable of performing any of the method 600 (for example, the first network device 120-1) may comprise means for performing the respective steps of the method 600. The means may be implemented in any suitable form. For example, the means may be implemented in a circuitry or software module.

The first apparatus comprises means for receiving a resource allocation request associated with a deterministic communication Quality of Service (QoS) flow; means for determining at least one recommended network device satisfying a deterministic requirement associated with the deterministic communication QoS flow; means for selecting at least one target network device from the at least one recommended network device; and means for transmitting, to the at least one target network device, an indication to allocate resources for at least one further deterministic communication QoS flow.

In some example embodiments, means for determining at least one recommended network device may comprise means for transmitting, to a controller, a deterministic event in response to the resource allocation request and means for receiving, from the controller, an indication of the at least one recommended network device.

In some example embodiments, a candidate network device is determined as a recommended network device in accordance with a determination that a performance prediction of the candidate network device is in accordance with the requirement associated with the deterministic event, and the performance prediction is determined based at least partly on transmission status information of the candidate network device according to a prediction model.

In some example embodiments, the first apparatus may comprise means for transmitting, to the controller, an indication that at least one target network device is selected for optimization.

In some example embodiments, the first apparatus may further comprise means for transmitting, to the controller, a new deterministic event upon receiving an indication of a change associated with the deterministic communication QoS flow; means for receiving, from the controller, an indication of at least one updated recommended network device satisfying a requirement associated with the new deterministic event; means for selecting at least one updated target network device from the at least one updated recommended network device; and means for transmitting, to the at least one updated target network device, an indication to allocate resources for at least one further deterministic communication QoS flow.

In alternative example embodiments, means for determining at least one recommended network device may comprise means for obtaining transmission status information of the at least one candidate network device associated with the deterministic communication QoS flow; means for determining a performance prediction of the at least one candidate network based at least partly on the transmission status information according to a prediction model; means for determining the candidate network device as a recommended network device in accordance with a determination that a performance prediction of a candidate network device is in accordance with the requirement associated with the deterministic event.

In alternative example embodiments, the first apparatus may further comprise means for transmitting, to at least one candidate network device, a request for updated transmission status information in accordance with a determination that a presence period of the transmission status information exceeds a predefined limit; and means for receiving, from the at least one candidate network, the updated transmission status information.

In alternative example embodiments, the first network device 120-1 may further optimize the prediction model based on the indication that at least one target network device is selected.

In alternative example embodiments, the first apparatus may further comprise means for determining at least one updated candidate network device based on the indication upon receiving at least one of: an indication of a change associated with the deterministic communication QoS flow or an indication that the at least one recommended network device is no longer suitable for the deterministic communication QoS flow; means for selecting at least one updated target network device from the at least one updated recommended network device; and means for transmitting, to the at least one updated target network device, an indication to allocate resources for at least one further deterministic communication QoS flow.

In some example embodiments, the first apparatus may further comprise means for transmitting, to the at least one candidate network device, an event subscription request for a deterministic event at the at least one candidate network device; and means for receiving, from the at least one candidate network device, a response indicating that a subscription is created.

In some example embodiments, the transmission status information may comprise at least one of the following: cell load; current performance information; reliability; and transmission latency.

In some example embodiments, the resource allocation request comprises at least one of the following: Time-Sensitive Communication Assistant Information, TSCAI; Quality of Service, QoS, parameters; a QoS Flow Identifier, QFI; and an indication of a redundant deterministic communication QoS flow.

In some example embodiments, the indication of the at least one recommended network device is comprised in a policy for a control plane.

In some example embodiments, the at least one candidate network device is capable of deterministic transmission and the requirement associated with the deterministic event indicates at least: a latency; a bandwidth; reliability of a candidate network device; and availability of a candidate network device.

In some example embodiments, a second apparatus capable of performing any of the method 700 (for example, the controller 130) may comprise means for performing the respective steps of the method 700. The means may be implemented in any suitable form. For example, the means may be implemented in a circuitry or software module.

The second apparatus comprises means for determining from at least one candidate network device, at least one recommended network device satisfying a requirement associated with the deterministic event upon receiving a deterministic event from a first network device. In this case, the deterministic event is in response to a resource allocation request received by the first network device associated with a deterministic communication QoS flow. The second apparatus comprises means for transmitting, to the first network device, an indication of the at least one recommended network device.

In some example embodiments, means for determining at least one recommended network device may comprises means for obtaining transmission status information of the at least one candidate network device associated with the deterministic communication QoS flow; means for determining a performance prediction of the at least one candidate network based at least partly on the transmission status information according to a prediction model; and means for determining the candidate network device as a recommended network device in accordance with a determination that a performance prediction of a candidate network device is in accordance with the requirement associated with the deterministic event.

In some example embodiments, the second apparatus may comprise means for transmitting, to at least one candidate network device, a request for updated transmission status information in accordance with a determination that a presence period of the transmission status information exceeds a predefined limit; and means for receiving, from the at least one candidate network, the updated transmission status information.

In some example embodiments, the second apparatus may comprise means for transmitting, to the first network device, a deterministic event subscription request for a deterministic event at the first network device; means for receiving, from the first network device, a response indicating that a subscription is created; means for transmitting, to the at least one candidate network device, an event subscription request for a deterministic event at the at least one candidate network device; and means for receiving, from the at least one candidate network device, a response indicating that a subscription is created.

In some example embodiments, the at least one candidate network device is capable of deterministic transmission and the requirement associated with the deterministic event indicates at least: a latency; a bandwidth; reliability of a candidate network device; and availability of a candidate network device.

In some example embodiments, the second apparatus may comprise means for receiving, from the first network device, an indication that at least one target network device is selected; and means for optimizing the prediction model based on the indication.

In some example embodiments, the second apparatus may comprise means for determining at least one updated recommended network device based on the indication upon receiving at least one of: an indication of a change associated with the deterministic communication QoS flow or an indication that the at least one recommended network device is no longer suitable for the deterministic communication QoS flow; and means for transmitting, to the first network device, an indication of the at least one updated recommended network device.

In some example embodiments, the transmission status information may comprise at least one of the following: cell load; current performance information; reliability; and transmission latency.

In some example embodiments, the resource allocation request comprises at least one of the following: Time-Sensitive Communication Assistant Information, TSCAI; Quality of Service, QoS, parameters; a QoS Flow Identifier, QFI; and an indication of a redundant deterministic communication QoS flow.

In some example embodiments, the indication of the at least one recommended network device is comprised in a policy for a control plane.

FIG. 8 is a simplified block diagram of a device 800 that is suitable for implementing embodiments of the present disclosure. The device 800 may be provided to implement the communication device, for example the first network device 120-1 and the controller 130 as shown in FIG. 1. As shown, the device 800 includes one or more processors 810, one or more memories 820 coupled to the processor 810, and one or more transmitters and/or receivers (TX/RX) 840 coupled to the processor 810.

The TX/RX 840 may be configured for bidirectional communications. The TX/RX 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage media. Examples of the volatile memories include, but are not limited to, a random access memory (RAM) 622 and other volatile memories that will not last in the power-down duration.

A computer program 830 includes computer executable instructions that may be executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIG. 2. The embodiments of the present disclosure may also be implemented by hardware or by a combination of software and hardware.

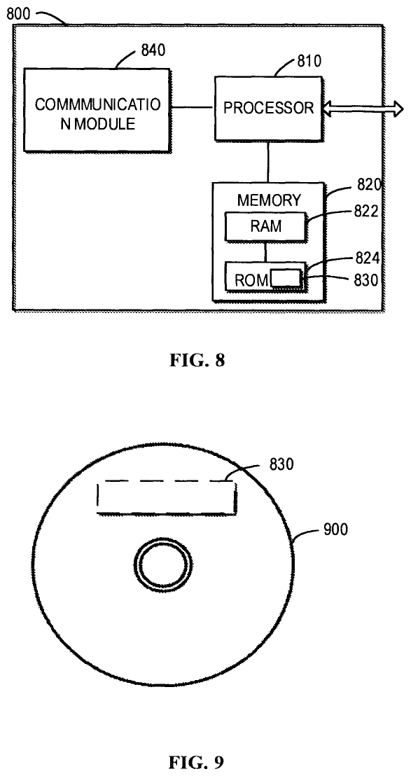

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9. shows an example of the computer readable medium 900 in form of CD or DVD. The computer readable medium has the program 930 stored thereon.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations. It is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 OR 700 as described above with reference to FIGS. 6-7. Generally, program modules may include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A device, comprising:
at least one processor; and
at least one memory including computer program codes;
the at least one memory and the computer program codes are configured to, with the at least one processor, cause the device at least to:
receive a resource allocation request associated with a deterministic communication traffic;
determine at least one recommended network device satisfying a deterministic requirement associated with the deterministic communication traffic;
select at least one target network device from the at least one recommended network device; and
transmit, to the at least one target network device, an indication to allocate resources for at least one further deterministic communication traffic.

2. The device of claim 1, wherein the at least one memory and the computer program codes are configured to, with the at least one processor, cause the device to determine at least one recommended network device by:
transmitting, to a controller, a deterministic event in response to the resource allocation request;
receiving, from the controller, an indication of the at least one recommended network device.

3. The device of claim 2, wherein a candidate network device is determined as a recommended network device in accordance with a determination that a performance prediction of the candidate network device is in accordance with the requirement associated with the deterministic event, and the performance prediction is determined based at least partly on transmission status information of the candidate network device according to a prediction model.

4. The device of claim 2, wherein the at least one memory and the computer program codes are configured to, with the at least one processor, further cause the device to:
transmit, to the controller, an indication that at least one target network device is selected for optimization.

5. The device of claim 2, wherein the at least one memory and the computer program codes are configured to, with the at least one processor, further cause the device to:
upon receiving an indication of a change associated with the deterministic communication traffic, transmit, to the controller, a new deterministic event;
receive, from the controller, an indication of at least one updated recommended network device satisfying a requirement associated with the new deterministic event;
select at least one updated target network device from the at least one updated recommended network device; and
transmit, to the at least one updated target network device, an indication to allocate resources for at least one further deterministic communication traffic.

6. The device of claim 1, wherein the at least one memory and the computer program codes are configured to, with the at least one processor, cause the device to determine at least one recommended network device by:
obtaining transmission status information of the at least one candidate network device associated with the deterministic communication traffic;
determining a performance prediction of the at least one candidate network based at least partly on the transmission status information according to a prediction model; and
in accordance with a determination that a performance prediction of a candidate network device is in accordance with the requirement associated with the deterministic event, determining the candidate network device as a recommended network device.

7. The device of claim 6, wherein the at least one memory and the computer program codes are configured to, with the at least one processor, further cause the device to:
in accordance with a determination that a presence period of the transmission status information exceeds a predefined limit, transmit, to at least one candidate network device, a request for updated transmission status information; and
receive, from the at least one candidate network, the updated transmission status information.

8. The device of claim 6, wherein the at least one memory and the computer program codes are configured to, with the at least one processor, further cause the device to:
optimize the prediction model based on the indication that at least one target network device is selected.

9. The device of claim 6, wherein the at least one memory and the computer program codes are configured to, with the at least one processor, further cause the device to:
upon receiving at least one of: an indication of a change associated with the deterministic communication traffic or an indication that the at least one recommended network device is no longer suitable for the deterministic communication traffic, determine at least one updated candidate network device based on the indication;
select at least one updated target network device from the at least one updated recommended network device; and
transmit, to the at least one updated target network device, an indication to allocate resources for at least one further deterministic communication traffic.

10. The device of claim 1, wherein the at least one memory and the computer program codes are configured to, with the at least one processor, further cause the device to:
transmit, to the at least one candidate network device, an event subscription request for a deterministic event at the at least one candidate network device; and
receive, from the at least one candidate network device, a response indicating that a subscription is created.

11-12. (canceled)

13. The device of claim 1, wherein the indication of the at least one recommended network device is comprised in a policy for a control plane.

14. (canceled)

15. A Controller, comprising:
at least one processor; and
at least one memory including computer program codes;
the at least one memory and the computer program codes are configured to, with the at least one processor, cause the controller at least to:
upon receiving a deterministic event from a first network device, determine, from at least one candidate network device, at least one recommended network device satisfying a requirement associated with the deterministic event, wherein the deterministic event is in response to a resource allocation request received by the first network device associated with a deterministic communication traffic; and
transmit, to the first network device, an indication of the at least one recommended network device.

16. The controller of claim 15, wherein the at least one memory and the computer program codes are configured to, with the at least one processor, cause the controller to determine at least one recommended network device by:
obtaining transmission status information of the at least one candidate network device associated with the deterministic communication traffic;
determining a performance prediction of the at least one candidate network based at least partly on the transmission status information according to a prediction model; and
in accordance with a determination that a performance prediction of a candidate network device is in accordance with the requirement associated with the deterministic event, determining the candidate network device as a recommended network device.

17. The controller of claim 16, wherein the at least one memory and the computer program codes are configured to, with the at least one processor, further cause the controller to:
in accordance with a determination that a presence period of the transmission status information exceeds a predefined limit, transmit, to at least one candidate network device, a request for updated transmission status information; and
receive, from the at least one candidate network, the updated transmission status information.

18. The controller of claim 15, wherein the at least one memory and the computer program codes are configured to, with the at least one processor, further cause the controller to:
transmit, to the first network device, a deterministic event subscription request for a deterministic event at the first network device;
receive, from the first network device, a response indicating that a subscription is created;
transmit, to the at least one candidate network device, an event subscription request for a deterministic event at the at least one candidate network device; and
receive, from the at least one candidate network device, a response indicating that a subscription is created.

19. (canceled)

20. The controller of claim 16, wherein the at least one memory and the computer program codes are configured to, with the at least one processor, further cause the controller to:
receive, from the first network device, an indication that at least one target network device is selected; and
optimize the prediction model based on the indication.

21. The controller of claim 15, wherein the at least one memory and the computer program codes are configured to, with the at least one processor, further cause the controller to:
upon receiving at least one of: an indication of a change associated with the deterministic communication traffic or an indication that the at least one recommended network device is no longer suitable for the deterministic communication traffic, determine at least one updated recommended network device based on the indication; and
transmit, to the first network device, an indication of the at least one updated recommended network device.

22-23. (canceled)

24. The controller of claim 15, wherein the indication of the at least one recommended network device is comprised in a policy for a control plane.

25. A method comprising:
receiving a resource allocation request associated with a deterministic communication traffic;
determining at least one recommended network device satisfying a deterministic requirement associated with the deterministic communication traffic;
selecting at least one target network device from the at least one recommended network device; and
transmitting, to the at least one target network device, an indication to allocate resources for at least one further deterministic communication traffic.

26-29. (canceled)
